(19) United States
(12) Patent Application Publication
(10) Pub. No.: US 2018/0284472 A1
(43) Pub. Date: Oct. 4, 2018

(54) LIGHT COLLIMATING STRUCTURE, LIGHT COLLIMATING SUBSTRATE, MANUFACTURING METHOD THEREOF, BACKLIGHT MODULE, AND DISPLAY DEVICE

(71) Applicant: BOE TECHNOLOGY GROUP CO., LTD., Beijing (CN)

(72) Inventors: Jifeng TAN, Beijing (CN); Wei WANG, Beijing (CN); Jian GAO, Beijing (CN); Yafeng YANG, Beijing (CN); Xiaochuan CHEN, Beijing (CN)

(73) Assignee: BOE Technology Group Co., Ltd., Beijing (CN)

(21) Appl. No.: 15/572,883

(22) PCT Filed: Apr. 1, 2017
(86) PCT No.: PCT/CN2017/079286

§ 371 Date: Nov. 9, 2017

(30) Foreign Application Priority Data
Aug. 30, 2016 (CN) 201610767030.4

(51) Int. Cl. G02B 27/30; F21V 7/04; G02B 27/09; F21V 5/04

(52) U.S. Cl. CPC G02B 27/30; F21V 7/04; F21V 5/04; G02B 27/0977; G02B 27/0955

(57) ABSTRACT

A light collimating structure, and a manufacturing method thereof, a light collimating substrate, a backlight module and the display device are disclosed. The light collimating structure includes: a lens having a first main axis and a first focal point; and a curved mirror having a second main axis and a second focal point; wherein the curved mirror is provided around the lens, the first main axis and the second main axis are coincident, and the first focal point and the second focal point are coincident, such that light emitted at the first focal point or the second focal point is collimated into parallel light parallel to the first main axis and the second main axis after transmitted through the lens or reflected by the curved mirror. The light collimating structure can collimate light, thereby improving the utilization of light energy, and reducing the power consumption of the display panel.

### TECHNICAL FIELD

Embodiments of the present invention relate to a light collimating structure, a light collimating substrate, a manufacturing method thereof, a backlight module and a display device.

### BACKGROUND

In recent years, with the rapid development of various types of display devices, its power consumption has been widespread concern. As the display panel backlight module emits light with a large divergence angle, the human eyes can only receive a small part of the light energy, significantly reducing the utilization of light energy, thereby increasing the power consumption of display panel. A backlight module capable of collimating the light is required, so as to reduce the divergence angle of the light emitted from the display panel, such that the outgoing light can be efficiently received by the human eye.

### SUMMARY

Embodiments of the present disclosure provide a light collimating structure comprising: a lens having a first main axis and a first focal point; a curved mirror having a second main axis and a second focal point. The curved mirror is provided around the lens, the first main axis and the second main axis are coincident, and the first focal point and the second focal point are coincident, such that light emitted at the first focal point or the second focal point is collimated into parallel light parallel to the first main axis and the second main axis after transmitted through the lens or reflected by the curved mirror.

For example, in the light collimating structure according to the embodiments of the present disclosure, the lens comprises s first surface and a second face, the first surface is planar, and the second surface is spherical.

For example, in the light collimating structure according to the embodiments of the present disclosure, the second surface of the lens is provided on a side of the lens adjacent to the first focal point.

For example, in the light collimating structure according to the embodiments of the present disclosure, the curved mirror comprises an outer surface and an inner surface, the inner surface has a cylindrical shape.

For example, in the light collimating structure according to the embodiments of the present disclosure, the inner surface of the curved mirror is in contact with a side surface of the lens.

For example, in the light collimating structure according to the embodiments of the present disclosure, an intersection of the outer surface of the curved mirror with a cross section passing through the second main axis is a part of a parabola.

For example, in the light collimating structure according to the embodiments of the present disclosure, the lens comprises s first surface and a second face, the first surface is planar, the second surface is spherical, the second surface of the lens is provided on a side of the lens adjacent to the first focal point, a line passing through a position where the first focal point and the second focal point coincide with each other and being tangent to the second surface of the lens intersects with the outer surface of the curved mirror.

For example, in the light collimating structure according to the embodiments of the present disclosure, materials for the lens comprise transparent resin.

For example, in the light collimating structure according to the embodiments of the present disclosure, materials for the curved mirror comprise transparent resin.

For example, the light collimating structure according to the embodiments of the present disclosure further comprises a reflecting layer, wherein the reflecting layer is disposed on the outer surface of the curved mirror.

For example, in the light collimating structure according to the embodiments of the present disclosure, materials for the reflecting layer comprise metal.

For example, the light collimating structure according to the embodiments of the present disclosure further comprises a filling layer, wherein the filling layer is disposed on the first surface of the lens and inside of the curved mirror.

For example, in the light collimating structure according to the embodiments of the present disclosure, the filling layer and the lens are made of the same material.

Embodiments of the present disclosure further provide a backlight module, which comprises a light collimating structure as described in any one embodiment of the present disclosure and a light source substrate, wherein a plurality of light sources are disposed on the light source substrate, and the plurality of light sources correspond to the plurality of light collimating structures in one-to-one manner.

For example, in the backlight module according to the embodiments of the present disclosure, the light source comprises a light emitting diode.

For example, in the backlight module according to the embodiments of the present disclosure, the light source is disposed on a position where the first focal point and the second focal point coincide with each other in the light collimating structure.

Embodiments of the present disclosure further provide a display device, which comprises a backlight module as described in any embodiment of the present disclosure.

Embodiments of the present disclosure further provide a method for manufacturing the light collimating structure as described in any embodiment of the present disclosure, the method comprising: providing a light collimating substrate, and forming a light collimating structure on the light collimating substrate through nanoimprinting process.

For example, in the method according to embodiments of the present disclosure, the lens and the curved mirror in the light collimating structure are formed integrally.

### BRIEF DESCRIPTION OF THE DRAWINGS

In order to clearly illustrate the technical solutions of the embodiments of the disclosure, the drawings of the embodiments will be briefly described in the following; it is obvious that the drawings described below are only related to some embodiments of the disclosure and thus are not limitative of the disclosure.

FIG. 1 is an illustrative view of a light collimating structure;

FIG. 2 is an illustrative view of a light collimating structure according to one embodiment of the present disclosure;

FIG. 3 is an optical path diagram of a lens when used for collating light;

FIG. 4 is an optical path diagram of a curved mirror when used for collimating light;

FIG. 5 is an illustrate view of an example of a light collimating structure according to one embodiment of the present disclosure;

FIG. 6 is an illustrative view of another example of the light collimating structure according to one embodiment of the present disclosure;

FIG. 7 is an illustrative structural view of a light collimating substrate according to another embodiment of the present disclosure;

FIG. 8 is an illustrative structural view of a backlight module according to still another embodiment of the present disclosure;

FIG. 9 is an illustrative structural view of a display device according to yet another embodiment of the present disclosure; and

FIG. 10 is a flow chart of a method for manufacturing a light collimating substrate according to still another embodiment of the present disclosure.

### DETAILED DESCRIPTION

The technical solution of embodiments of the present disclosure will be described clearly and fully in connection with the drawings and with reference to the non-limiting exemplary embodiments illustrated in the drawings and detailed in the following description, exemplary embodiments and their various features and advantageous details will be fully explained. It should be noted that, the features in the figures are not drawn according to scale. The present disclosure omits the description of known materials, components, and process techniques so as not to obscure the exemplary embodiments of the present disclosure. The examples given are intended only to facilitate the understanding of the practice of the exemplary embodiments of the present disclosure and to further enable those skilled in the art to implement exemplary embodiments. Thus, these examples should not be construed as limiting the scope of the embodiments of the present disclosure.

Unless otherwise specifically defined, technical terms or scientific terms used in this disclosure should be understood in the ordinary sense of those skilled in the art to which this disclosure belongs. The “first”, “second” and similar words used in this disclosure do not denote any order, quantity or importance, but are merely used to distinguish between different components. In addition, in the various embodiments of the present disclosure, the same or similar reference numerals denote the same or similar members.

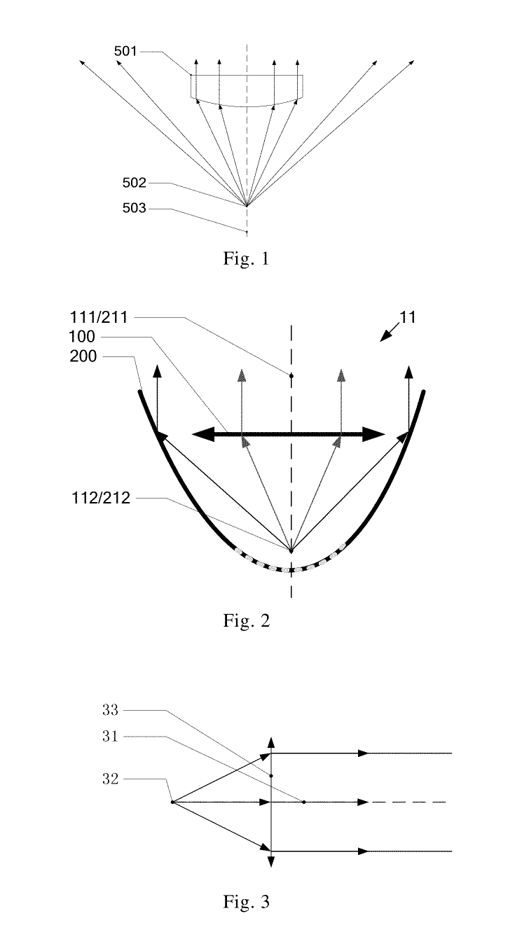

For example, FIG. 1 illustrates a light collimating structure. The light collimating structure comprises a lens 501 which has a focal point 502 and a main axis 503, and a light emitting point is placed on the focal point 502. An angle formed by the aperture of the lens 501 (i.e., the diameter of the lens 501 in the direction perpendicular to the direction of the main shaft 503) and the light emitting point is referred to as the lens aperture angle, which describes the size of the lens receiving cone angle. The light emitted by the light emitting point within the lens aperture angle is transmitted through the lens 501 and collimated to parallel light parallel to the main axis 503, and light located outside the lens aperture angle will be transmitted in original directions. Therefore, the light collimating structure only works for light within the lens aperture angle, and light outside the lens aperture angle will not be collimated. Thus, the light energy utilization rate during the collimation process is low, increasing power consumption of the related device comprising the light collimating structure.

In order to improve light energy utilization in the collimation process so as to reduce power consumption, it is required to make more light from the light emitting point emitted in the direction of the main axis 503. And for the light collimating structure illustrated in FIG. 1, it means to increase the lens aperture angle. And there are two ways to do so. The first is to increase the aperture of the lens 501, i.e., increase the side of the lens 501 in the direction perpendicular to the main axis 503. However, increase in size of the lens 501 will higher the cost of the lens and increase the volume of the light collimating structure. And the second is to reduce the distance between the light emitting point and the lens 501 by using a lens having a small focus, thereby raising the aperture angle of the lens 501 while maintaining the side of the lens 501. However, the small focus lens has a small curvature radius and a large curvature, so the processing is difficult and the production cost is high. In addition, the use of small focus lens will make the assembly tolerance between the light collimation structure and light source reduced, increasing the difficulty of assembly and manufacturing costs.

Embodiments of the present disclosure provide a light collimating structure, a light collimating substrate and a manufacturing thereof, a backlight module and a display device. The light collimating structure can collimate light, improve the utilization of light energy, thereby reducing the power consumption of display panel.

For example, FIG. 2 illustrates a light collimating structure 11 according to one embodiment of the present disclosure. The light collimating structure 11 comprises a lens 100 and a curved mirror 200. The lens 100 has a first main axis 111 and a first focal point 112; and the curved mirror 200 has a second main axis 211 and a second focal point 212. The curved mirror 200 is provided around the lens 100 (for example, the lens 100 disposed inside the curved mirror 200), the first main axis 111 and the second main axis 211 are coincident, and the first focal point 112 and the second focal point 212 are coincident, such that light emitted at the first focal point 112 or the second focal point 212 is collimated into parallel light parallel to the first main axis 111 and the second main axis 211 after transmitted through the lens 100 or reflected by the curved mirror 200.

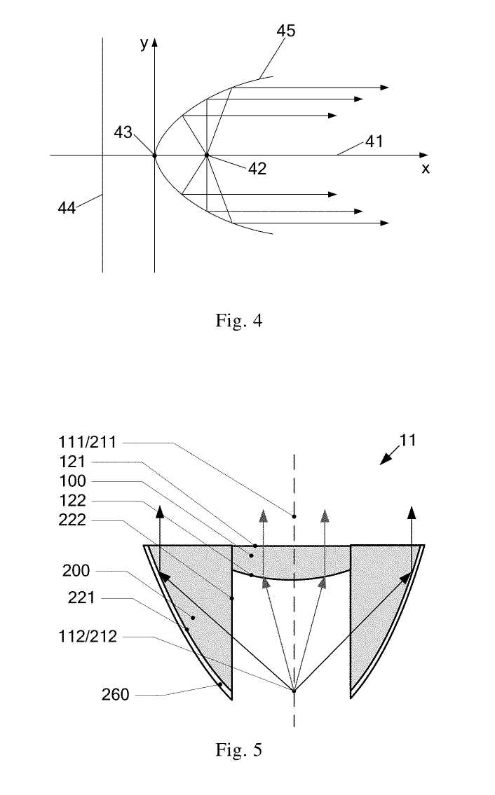

The operation principle of the lens and the curved mirror collimating light will be described below with reference to FIGS. 3 and 4.

For example, FIG. 3 illustrates how the lens works for collimating light. As illustrated in FIG. 3, the lens 33 has a main axis 31 and a focal point 32. When a light emitting point is provided at the focal point 32 of the lens 33, light emitted from the light emitting point within the lens aperture angle will be emitted in a direction parallel to the main axis 31. Thus, the lens 33 can collimate light within the lens aperture angle.

For example, FIG. 4 illustrates how the curved mirror works for collimating light. The curved mirror 45 has a main axis 41, a focus point 42 and a vertex 43. In order for concise, only a parabola obtained by intersecting the outer surface of the curved mirror with a cross section passing through the main axis 41 is illustrated. In order to facilitate the elaboration of the nature of the parabola, the Cartesian coordinate system is introduced. The coordinate origin is set on the vertex 43 of the parabola, the x-axis is disposed on the main axis 41 of the parabola, and the y-axis is set to be tangent to the parabola vertex 43. For example, the function expression of the parabola can be y²=2px, and the line at the position of x=−p/2 is called the main line 44. From the nature of the parabola, it can be seen that the distance from any point on the parabola to the focal point 42 is equal to the distance from the point to the main line 44. Thus, the distance from the incident parallel light to the focal point 42 is equal to its distance to the main line 44. Since the distance from the incident parallel light to the main line 44 is equal, the distance of the incident parallel light to the focal point 42 after reflected by the parabola is equal. By extending the properties of the parabola to the paraboloid, it can be determined that the distance of the incident parallel light to the focal point 42 after reflected by the paraboloid is equal. Therefore, the paraboloid is an aplanatic surface for the incident parallel light, and the focal point 42 is the perfect image point after the incident parallel light is reflected by the paraboloid. According to the reversibility principle of the optical path, it is known that the light emitted from the focal point 42 is reflected by the paraboloid and then emitted in the direction parallel to the main axis 41. So when the light emitting point is set at the focal point 42, the paraboloid has a collimating effect on light emitted from the light emitting point.

For example, when the curved mirror 200 is provided around the lens 100, the first main axis 111 and the second main axis 211 coincide, and the first focus 112 and the second focus 212 coincide, a light emitting point is set at a position where the first focal point 112 and the second focal point 212 coincide, and light emitted from the light emitting point within the lens aperture angle will be emitted in a direction parallel to the first main axis 111, and light being outside the lens aperture angle and reflected by the curved mirror 200 will exit in a direction parallel to the second main axis 211. As the first main axis 111 and the second main axis 211 coincide, the light emitted from the light emitting point and transmitted through the lens 100 and reflected by the curved mirror 200 is collimated to parallel light parallel to the first main axis 111 and the second main axis 211. Thus, more light from the light emitting point can be emitted along the direction of the first main axis 111 and the second main axis 211, thereby improving the light energy utilization rate of the light source during collimation, thereby reducing the power consumption.

For example, in the embodiment of the present disclosure, the lens 100 can be a lens having a collimating effect such as a flat convex type, a biconvex type, a spherical type, an aspherical type and the like. The curved mirror 200 can be provided in such a manner that the inner surface reflects the light or is arranged in such a manner that the outer surface reflects the light. For example, a portion corresponding to the back surface of the light source (i.e., away from the side of the lens) may not be provided with a reflective surface, thereby facilitating fixing the light source and collimating light.

For example, depending on the practical application scenario, the fixation manner for the lens 100 and the curved mirror 200 can be selected. For example, the lens 100 can be provided on a transparent substrate, and the curved surface mirror 200 with a reflective outer surface can be provided on the transparent substrate by mosaic or pasting.

FIG. 5 illustrates an example of a light collimating structure 11 according to one embodiment of the present disclosure. For example, the lens 100 is a flat convex type lens, and the outer surface of the curved mirror 200 reflects the light, and the back surface of the light source is not provided with a reflecting surface. The lens 100 and the curved mirror 200 can be provided directly or indirectly on a substrate (not shown in FIG. 5).

For example, the lens 100 comprises a first surface 121 and a second surface 122, the first face 121 being planar and the second face 122 being spherical. And the second surface 122 of the lens 100 is provided on the side of the lens 100 adjacent to the first focus 112. When the light emitting point is set on the first focal point 112, light beam emitted from the light emitting point within the lens aperture angle will be collimated into parallel light parallel to the first main axis 111.

For example, the curved mirror 200 includes an outer surface 221 and a cylindrical inner surface 222. The inner surface 222 of the curved mirror 200 is, for example, in contact with the side surface of the lens 100 to prevent light from outgoing between the lens 100 and the curved mirror 200, so as to avoid lowering the light energy utilization.

For example, the curved mirror 200 is a parabolic reflector.

For example, the intersection of the outer surface 221 of the curved mirror 200 with a cross section passing through the second main axis 211 is a part of a parabola. That is, the shape of the outer surface 221 of the curved mirror 200 is a part of a paraboloid and is not limited to that the outer surface 221 of the entire curved mirror 200 is defined by the parameters of the same paraboloid. When the light emitting point is set on the second focal point 212, light from the light emitting point reflected by the curved mirror 200 will be collimated into parallel light parallel to the second main axis 211. The focal point of the paraboloid formed by the outer surface 221 of the curved mirror 200 is not completely coincident with the second focal point 212 due to the refraction by the inner surface 222 of the curved mirror 200 so that the second focal point 212 is offset away from the parabolic apex along the second main axis 211. For example, the position of the second focal point 212 can be calculated by refraction calculation formula n sin a=n′ sin β and in combination with the size of the lens 100 and the curved mirror 200. For example, the position of the second focal point 212 can be obtained by irradiating the curved mirror 200 with parallel light and testing the position with maximum light intensity.

For example, the material for the lens 100 can be a material having a high transmittance for the wavelength of light to be collimated. For example, for the light of the visible light band emitted by the OLED to be collimated, the material for the lens 100 can be selected as a resin that is transparent to visible light.

For example, the material for the lens 100 includes, but not limited to, a resin, or other material that is transparent to the wavelength of light to be collimated.

For example, for the curved mirror 200 in this example, the material can be a material (e.g., resin) having a high transmittance for the wavelength of the light source to be collimated. At this time, when the light to be collimated is transmitted through the curved mirror 200 to the outer surface 221 of the curved mirror 200, at least part of the light to be collimated will be reflected and emitted along the second main axis 211. When the incident angle of the light to be collimated satisfies the total reflection condition, all the light to be collimated incident on the curved mirror 200 will be reflected and emitted along the second main axis 211. The light collimating structure 11 can further include a reflective layer 260 disposed on the outer side of the outer surface 221 of the curved mirror 200 in order to further enhance the reflectivity of the curved mirror 200 in the example for the light to be collimated. The material of the reflective layer 260 may be a metallic material or a non-metallic reflective material.

It should be noted that the material for the curved mirror 200 is not limited to a material having a high transmittance for the wavelength of the light source to be collimated. When the curved mirror 200 is provided in such a manner that the inner surface reflects the light, the material for the curved mirror 200 can be a metal (e.g., aluminum, silver, gold, copper, etc.) having a high reflectance for the wavelength of the light source to be collimated.

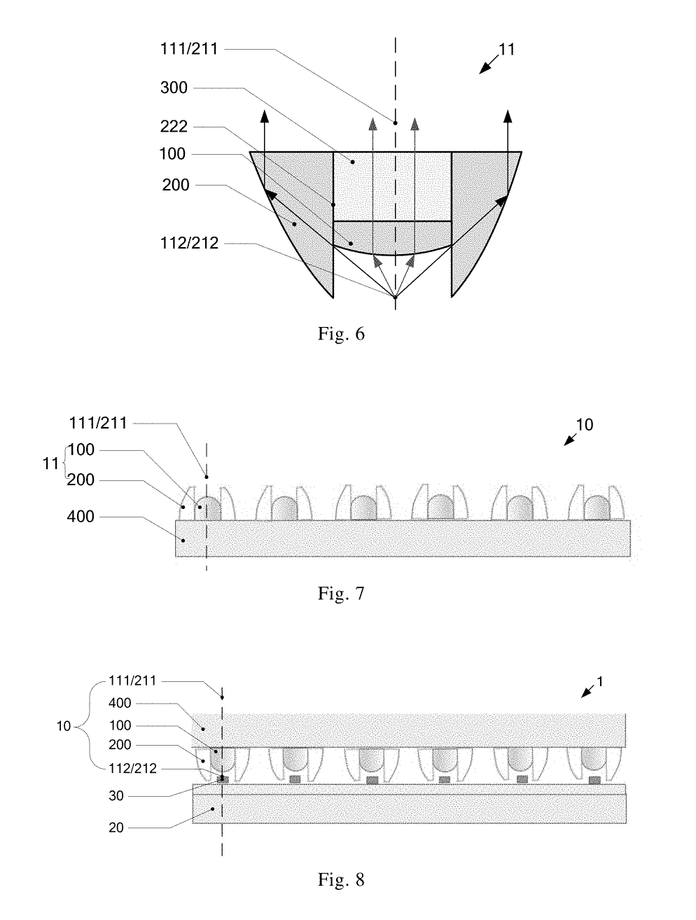

For example, in order to allow the light collimating structure 11 to exit more light from the light emitting point in the direction parallel to the first main shaft 111 or the second main axis 211, it is necessary to make the first main axis 111 and the second main axis 211 coincide with each other and to make the first focal point 112 and the second focal point 212 coincide. In order to achieve coincidence of the first focal point 112 and the second focal point 212, the light collimating structure 11 further comprises a filling layer 300. As illustrated in FIG. 6, the filling layer 300 is provided inside the curved mirror 200 and is provided in contact with the first surface 121 of the lens 100 so as to prevent light from being reflected on the surface of the filling layer 300 to avoid lowering the light energy utilization. The material for the filling layer 300 can be a material having a high transmittance for the wavelength of the light source to be collimated. For example, the material for the filling layer 300 can be the same as the material for the lens 100.

For example, the relationship among the focus f of the lens and the radius of curvature r of the lens second surface 122, the refractive index n2 of the lens and the external refractive index n1 of the lens is f=n1×r/(n2−n1). The focus f of the lens, the radius of curvature r of the second surface 122 of the lens, the refractive index n2 of the lens, and the external refractive index n1 of the lens can be selected according to the characteristics of the light emitting source.

For example, n1=1.47, n2=1.5164, r=89.57 μm, f=254.97 μm. When the diameter of the lens 100 is D=60 μm, the lens 100 has a height h=5.174 μm.

In one example, the function expression of the parabola obtained by the curved mirror 200 and the cross section passing through the second main axis 211 can be y²=2px, and the parameter p can be arbitrarily selected, thereby achieving collimation of the outgoing light. However, in order to enable the curved mirror 200 to collimate more light outside the lens aperture angle, the parameter p is set after considering the focus of the lens 100, the aperture of the lens, and the thickness of the filling layer 300.

For example, the curved mirror 200 needs to contain the lens 100, and a line passing the position where the first focus 112 and the second focal point 212 coincide and tangent to the second face 122 of the lens 100 and the outer surface 221 of the curved mirror 200 intersect. Then, all the light located outside the leans aperture angle to be collimated are incident on the curved mirror 200 and reflected by the curved mirror 200 and emitted along the second main axis 211. At this time, all the light located outside the lens aperture angle to be collimated are incident on the curved mirror 200 and reflected by the curved mirror 200 and emitted along the second main axis 211. Then, all the light emitted from the light emitting point after transmitted by the lens and reflected by the curved mirror 200 are collimated to parallel light parallel to the first main axis 111 and the second main axis 211. As a result, the light energy utilization during the collimation process is improved, and the power consumption of the display device is reduced.

Another embodiment of the present disclosure provides a light collimating substrate 10. As illustrated in FIG. 7, the light collimating substrate 10 comprises a substrate 400 and a plurality of light collimating structure 11 as described above. Since the lens 100 can collimate the light to be collimated in the lens aperture angle into parallel light parallel to the first main axis 111, the curved mirror 200 can collimate the light to be collimated outside the lens aperture angle into parallel light parallel to the second main axis 211, thereby enhancing the utilization ratio of light energy.

Still another embodiment of the present disclosure provides a backlight module 1. As illustrated in FIG. 8, the backlight module 1 comprises the light collimating substrate 10 as described above and a light source substrate 20, wherein a plurality of light sources 30 are disposed on the light source substrate 20 and the plurality of light sources 30 correspond to the plurality of light collimating structure 11 in a manner of one-to-one. In this embodiment, the type of the light source 30 can be selected according to the practical application scenarios. For example, the light source 30 can be a point light source, for example, a light emitting diode, such as an organic light emitting diode or an inorganic light emitting diode, and the like.

For example, the light source 30 can be provided at a position where the first focal point 112 and the second focal point 212 coincide in the light collimating structure 11. Thus, the lens 100 can collimate the light within the lens aperture angle to be collimated into parallel light parallel to the first main axis 111. The curved mirror 200 can collimate the light outside the lens aperture angle to be collimated into parallel light parallel to the second main axis 211, the utilization ratio of the light energy during the collimation process is improved, and the power consumption of the backlight module is reduced.

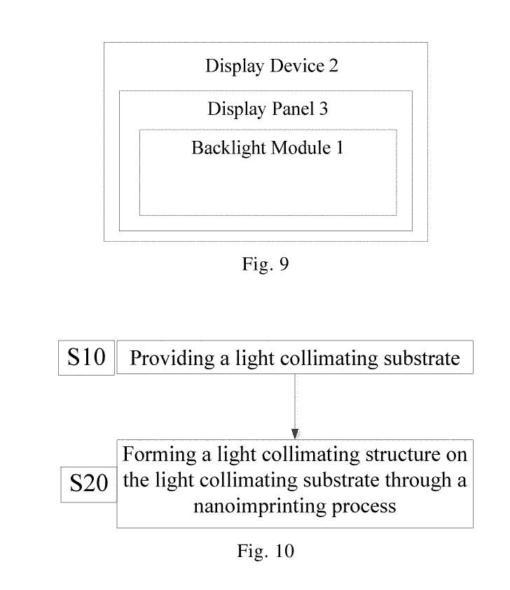

Yet still another embodiment of the present disclosure provides a display device. As illustrated in FIG. 9, the display device 2 comprises a display panel 3. The display panel 3 comprises the backlight module 1 as described in any embodiment of the present disclosure. For example, the display panel 3 can be a liquid crystal display panel. Since the lens can collimate the light to be collimated in the lens aperture angle into parallel light parallel to the first main axis 111, the curved mirror 200 can collimate the light to be collimated outside the lens aperture angle into parallel light parallel to the second main axis 211, the utilization ratio of the light energy during the collimation process is improved, and the power consumption of the display device is reduced.

Yet still another embodiment of the present disclosure provides a method for manufacturing the light collimating substrate 10. As illustrated in FIG. 10, the method comprising the following steps:

Step S10: providing a light collimating substrate;

Step S20: forming a light collimation structure on the light collimating substrate by a nanoimprint process. For example, in the present embodiment, the lens 100 and the curved mirror 200 in the light collimating structure 11 can be integrally formed. Due to the absence of expensive light sources and optical projection systems, the manufacturing cost of nanoimprint lithography is significantly reduced compared to conventional lithography methods. Thus, the light collimating substrate 10 can be obtained without increasing the manufacturing difficulty, the manufacturing cost, or the volume of collimation system, can be made such that more light from the light emitting point can be emitted in the direction of the main axis, thereby the utilization ratio of the light source during the collimation by the light collimating substrate 10 is reduced, and the power consumption of related devices including the light collimating substrate 10 (e.g., display panel or display device) is reduced.

Embodiments of the present disclosure provide a light collimating structure, a light collimating substrate and a manufacturing method thereof, a backlight module and a display device, for collimating light, thereby improving the utilization ratio of light energy, and reducing power consumption of a display device.

While the present disclosure has been described in detail by way of general description and specific embodiments thereof, it will be apparent to those skilled in the art that modifications and improvements may be made thereto without departing from the spirit and scope of the invention. Accordingly, such modifications or improvements as do not depart from the spirit of the present disclosure are within the scope of the present disclosure.

The present disclosure claims priority of Chinese Patent Application No. 201610767030.4 filed on Aug. 30, 2016, the disclosure of which is hereby entirely incorporated by reference as a part of the present disclosure.

1: A light collimating structure, comprising:
a lens having a first main axis and a first focal point; and
a curved mirror having a second main axis and a second focal point;
wherein the curved mirror is provided around the lens, the first main axis and the second main axis are coincident, and the first focal point and the second focal point are coincident, such that light emitted at the first focal point or the second focal point is collimated into parallel light parallel to the first main axis and the second main axis after transmitted through the lens or reflected by the curved mirror.

2: The light collimating structure according to claim 1, wherein the lens comprises a first surface and a second face, the first surface is planar, and the second surface is spherical.

3: The light collimating structure according to claim 2, wherein the second surface of the lens is provided on a side of the lens adjacent to the first focal point.

4: The light collimating structure according to claim 1, wherein the curved mirror comprises an outer surface and an inner surface, the inner surface has a cylindrical shape.

5: The light collimating structure according to claim 4, wherein the inner surface of the curved mirror is in contact with a side surface of the lens.

6: The light collimating structure according to claim 4, wherein an intersection of the outer surface of the curved mirror with a cross section passing through the second main axis is a part of a parabola.

7: The light collimating structure according to claim 4, wherein the lens comprises a first surface and a second face, the first surface is planar, the second surface is spherical, the second surface of the lens is provided on a side of the lens adjacent to the first focal point, a line passing through a position where the first focal point and the second focal point coincide with each other and being tangent to the second surface of the lens intersects with the outer surface of the curved mirror.

8: The light collimating structure according to claim 1, wherein materials for the lens comprise transparent resin.

9: The light collimating structure according to claim 1, wherein materials for the curved mirror comprise transparent resin.

10: The light collimating structure according to claim 4, further comprising a reflecting layer, wherein the reflecting layer is disposed on the outer surface of the curved mirror.

11: The light collimating structure according to claim 10, wherein materials for the reflecting layer comprise a metal.

12: The light collimating structure according to claim 2, further comprising a filling layer, wherein the filling layer is disposed on the first surface of the lens and inside of the curved mirror.

13: The light collimating structure according to claim 12, wherein the filling layer and the lens are made of the same material.

14: A light collimating substrate, comprising the light collimating structure according to claim 1.

15: A backlight module, which comprises a light collimating substrate according to claim 14 and a light source substrate, wherein a plurality of light sources are disposed on the light source substrate, and the plurality of light sources correspond to the plurality of light collimating structures in one-to-one manner.

16: The backlight module according claim 15, wherein the light source comprises a light emitting diode.

17: The backlight module according claim 15, wherein the light source is disposed on a position where the first focal point and the second focal point coincide with each other in the light collimating structure.

18: A display device comprising a backlight module according to claim 15.

19: A method for manufacturing the light collimating structure according to claim 14, comprising: providing a light collimating substrate, and forming a light collimating structure on the light collimating substrate through a nanoimprinting process.

20: The method according to claim 19, wherein the lens and the curved mirror in the light collimating structure are formed integrally.
